(19) United States
(12) Patent Application Publication
(10) Pub. No.: US 2003/0001650 A1
(43) Pub. Date: Jan. 2, 2003

(54) Delay compensation circuit including a feedback loop

(76) Inventors: Xianguo Cao, Pudong Shanghai (CN); Obed Duardo, Coral Springs, FL (US); Bo Ye, Pudong Shanghai (CN)

Correspondence Address: HARNESS, DICKEY & PIERCE, P.L.C., P.O. BOX 8910, RESTON, VA, 20195, US

(21) Appl. No.: 09/991,330

(22) Filed: Nov. 15, 2001

(30) Foreign Application Priority Data
Jul. 2, 2001 (CN) 01132531.3

(51) Int. Cl. G06F 7/38

(52) U.S. Cl. 327/277

(57) ABSTRACT

A delay compensation circuit that determines the effects of process, voltage, and temperature (PVT) conditions of a chip by amplifying the maximum delay time of a delay element within the chip. The delay compensation circuit determines into which one of several predefined time intervals the amplified delay time falls, where each predefined time interval is associated with different PVT conditions. The delay compensation circuit of the present invention can be used to generate control signals for a variable delay element. Also, the PVT information provided by the delay compensation circuit can be used to design components within a chip to compensate for variances in PVT conditions. The feedback loop structure of the delay compensation device reduces the required chip area and power consumption of the delay compensation circuit.

### BACKGROUND OF THE INVENTION

The present invention relates generally to synchronous circuit design, and more particularly, to a variable delay control circuit for providing a variable delay time to a clock signal to compensate for variations in the process, voltage and temperature (PVT) conditions of an integrated circuit.

### DESCRIPTION OF THE RELATED ART

In digital circuits, synchronous logic elements operate by accepting and locking into a data signal during a transition of a clock signal. Such logic elements include D flip-flops, latch circuits, linear feedback shift registers (LFSRs), and counters. In order for a synchronous logic element to lock into a data signal, the signal must remain stable for some time prior to the clock edge, i.e., during a setup time. Also, the data signal usually must remain stable for some time after the clock edge, i.e., during a hold time, to be locked in by the synchronous logic element. If the data signal is not stable for both the setup time and the hold time of a synchronous logic element, the data signal may or may not be captured by the logic element.

FIG. 1A illustrates the operation of a synchronous logic element, specifically a D flip-flop DFF. In this example, the input data signal A is also used as the clock signal. Typically, the data signal and the clock signal are not shared, but instead are distinct signals. They are shown as sharing the same signal in FIG. 1 to simplify the description of the related art. All descriptions herein apply also to the case where the clock and data signals are distinct.

As shown in the timing diagrams of FIG. 1A, signal A is applied at the D input and clock input CK of the D flip-flop DFF. Therefore, the required setup time Tₛᵤ of the D flip-flop DFF cannot be satisfied, and the Q output is indeterminate. This is shown in the timing diagram of FIG. 1A. However, such violations of setup time are not limited to instances where the input data signal is used to clock itself in a synchronous logic element.

For instance, clock skew (i.e., minor variations in the time at which clock signals arrive at their destinations in a chip) may cause the clock signal to arrive earlier than expected. Therefore, clock skew may cause a data signal to violate the setup time. Clock skew can be caused by, among other things, the process, voltage, and temperature (PVT) conditions of the synchronous logic element.

One way to prevent setup time violations is to add a delay element to the path of the clock signal. FIG. 1B shows a delay element added to the clock path of the D flip-flop DFF in FIG. 1A. As shown in the timing diagram of FIG. 1B, the delay element delays the signal A applied to the CK input by a time T_{d}, thereby shifting the clock edge such that the data signal is stable during the setup time Tₛᵤ.

However, the delay time T_{d} may vary according to the PVT conditions of the delay element. For example, if the temperature varies between from about −40° C. to 125° C., the supply voltage varies by +/−15%, and/or the process conditions of the delay element varies between worst case fast and worst case slow, the delay time T_{d} may vary from below 50% to over 100% of the designated delay time T_{d}. Such changes in delay time T_{d} may result in a violation of the setup time or the hold time of the D flip-flop DFF, or other types of synchronous logic elements.

One solution to this problem has been to use a type of delay element that includes a certain number of small delay cells, each having a relatively small delay time. The delay time T_{d} of such a delay element can be adapted to compensate for PVT conditions by changing the number of smaller delay cells. In order to increase the resolution of the delay element further, the smaller delay cells may comprise a tapped delay circuit, which includes a coarse delay component and a fine delay component.

FIG. 2 illustrates such a tapped delay circuit 10. The coarse delay component is comprised of a group of tapped coarse delay elements CD1, . . . , CD8 connected in series. The fine delay component is comprised of a plurality of tapped fine delay elements FDa, . . . , FDd connected in parallel. While FIG. 2 shows a delay component having eight coarse delay elements CD1, . . . , CD8 and four fine delay elements FDa, . . . , FDd, the number of delay elements included in the tapped delay circuit 10 can be increased or decreased based on the desired resolution of the delay time.

Each of the coarse delay elements CD1, . . . , CD8 has a relatively short time delay T_{c}. An input signal IN is input to the first coarse delay element, and the delayed signal propagates from coarse delay element CD1 to the next coarse delay element CD2 to the next coarse delay element CD3, etc., until it propagates to the last coarse delay element CD8. Therefore, the signal at tap 1 will be delayed by T_{c}, the signal at tap 2 will be delayed by 2*T_{c}, and so forth. The coarse delay multiplexor MUX A is controlled by a shift register array 30 to select the tap signal corresponding to a specific series number, which is transmitted to MUX A from the shift register array 30 via control signals.

The delayed signal selected by multiplexor MUX A is then transmitted to the fine delay elements FDa, . . . , FDd in the fine delay component. The fine delay component is used to fine-tune the delay time of the variable delay circuit. The time delay T_{f} of the fine delay component is much smaller than the time delay T_{c} of the coarse delay elements. Each fine delay element FDa, . . . , FDd has a time delay T_{f} that corresponds to the element's capacitance load. This time delay T_{f} includes an intrinsic time delay that is independent of the capacitance load and an extrinsic time delay that typically varies linearly with the capacitance load. For example, since the capacitance load of FDd is four times greater than the capacitance load of FDa, the extrinsic time delay applied to the signal by delay element FDd will be four times longer than the extrinsic time delay applied by delay element FDa. The intrinsic time delay applied to the signal by any fine delay element Fda, . . . , FDd is the same. The shift register array 30 determines a parallel number (either a, b, c, or d), and controls the fine delay multiplexor MUX B to select and output the signal at the tap corresponding to the determined parallel number.

The series number determined by the shift register array 30 includes a number of bits that corresponds to the number of coarse delay elements CD1, . . . , CD8. Therefore, in the tapped delay circuit 10 illustrated in FIG. 2, the shift register array contains a series number having eight digits. Each digit corresponds to the tap of a specific coarse delay element. One of the digits contains a “1” bit while all of the other digits contain “0” bits. The digit containing the “1” bit corresponds to the tap whose delayed signal is selected by coarse delay multiplexor MUX A. Similarly, the parallel number includes a number of bits corresponding to the number of fine delay elements FDa, . . . , FDd, wherein one digit contains a “1” bit while the other digits contain “0” bits. The “1” bit corresponds to the tap from which fine delay multiplexor MUX B selects the delayed signal.

FIG. 3 illustrates a variable delay control circuit 100 that utilizes a variable delay element 20, which is comprised of a number of tapped delay circuits 10. The number of tapped delay circuits 10 in variable delay element 20 is based on the desired resolution of the variable delay control circuit 100. The time delay T_{d} of the variable delay element 20 is the sum of the coarse delay times T_{c} and the fine delay times T_{f} of each tapped delay circuit 10. Therefore, in order to compensate for PVT conditions, the time delay T_{d} is adjusted by changing the series number and parallel number of the shift register array 30. The operation of the variable delay control circuit 100 is described below.

First, an input clock signal CLK is input to the first tapped delay circuit 10 of the variable delay element 20. The variable delay element 20 outputs a clock signal P_CK delayed according to delay time T_{d}, which is determined by the series number and the parallel number in the shift register array 30. Both the delayed clock signal P_CK and the input clock signal CLK are sent to coarse phase detector 40, which detects a phase difference between the input clock CLK and the delayed clock signal P_CK. The signals P_CK and CLK are also sent to the fine phase detector 50, which similarly detects a phase difference between the signals.

Based on a detected phase difference, the coarse phase detector 40 will generate either right shift signal CSR or a left shift signal CSL, if necessary, which shifts the “1” bit of the series number in the shift register array 30 to either the left or right. As a result of the modified series number, the coarse delay multiplexor MUX A of each tapped delay element 10 will select and output a different tap signal. Similarly, the fine phase detector 50 will generate a right shift signal FSR or a left shift signal FSL to shift the “1” bit of the parallel number of the shift register array 30 to either the left or right, if such a shift is necessary according to the detected phase difference. Such shifts will cause the fine delay multiplexor MUX B of each tapped delay element 10 to select a different tap signal.

The variable delay control circuit 100 of FIG. 2 can be considered a type of delay-locked loop (DLL), because it synchronizes or aligns the delayed clock signal P_CK with the input clock signal CLK.

FIG. 4 illustrates a timing diagram with internal signals P_d0, P_d1, P_d2, and P_d3, which are determined with respect to the phase of clock signal CLK. The coarse phase detector 40 compares the P_CK signal to P_d0 and P_d1, while the fine phase detector 50 compares P_CK to P_d2 and P_d3, to determine whether adjustments to the series number and parallel number are necessary. Signals P_d0 and P_d1 define the boundaries of a coarse delay window T_{cd}. Signals P_d2 and P_d3 define the boundaries of a fine delay window T_{fd}.

Specifically, the coarse phase detector 40 checks whether the rising edge of signal P_CK falls between the rising edges of signals P_d0 and P_d1, i.e., falls within coarse delay window T_{cd}. If the edge of P_CK does not fall within window T_{cd}, then the coarse phase detector will generate CSR or CSL signals to modify the series number, thereby causing P_CK to shift. For instance, if the rising edge of P_CK falls within time interval R1 of FIG. 4, where both P_d0 and P_d1 are high, the coarse phase detector 40 will generate a right shift signal CSR that causes the series number to decrease (i.e., cause the “1” bit to shift to the right) and P_CK to coarsely shift toward the left. Alternatively, if the rising edge of P_CK falls within time interval L1, where both P_d0 and P_d1 are low, the coarse phase detector 40 will generate a left shift signal CSL that causes the series number to increase (i.e., cause the “1” bit to shift to the left) and P_CK to move coarsely toward the right.

Once the edge signal P_CK falls within coarse delay window T_{cd}, fine coarse detector 50 will determine whether the edge of P_CK falls between the rising edges of signal P_d2 and P_d3, i.e., falls within fine delay window T_{fd}. If the edge of P_CK does not fall within window T_{fd}, the fine phase detector 50 will similarly generate right shift signal FSR and left shift signal FSL to alter the parallel number, and finely shift signal P_CK. For example, if the rising edge of P_CK falls to the right of window T_{fd}, a right shift signal FSR will decrease the parallel number (i.e., cause the “1” bit to shift to the right), thereby shifting P_CK to the left. If the edge of P_CK falls to the left of window T_{fd}, a left shift signal FSL will increase the parallel number (i.e., cause the “1” bit to shift to the left), thereby shifting P_CK to the right.

However, a problem may arise when using the variable control system 100. Specifically, when the system is powered on, the series number may be preset to a number that causes P_CK to be ahead of input clock signal CLK by a half cycle, or preset to a number that causes P_CK to be delayed by a full cycle with respect to CLK. Such a problem can be attributed to variations in PVT conditions, and may cause the delay times of the coarse delay and fine delay elements of the tapped delay circuits 10 to vary from below −50% to above 100% of the normal delay time.

As a result of this problem, the edge of signal P_CK may fall within one of the time intervals L3, S3, and R3 of the timing diagram in FIG. 4. Consequently, the coarse phase detector 40 and fine phase detector 50 will generate right shift (CSR, FSR) or left shift (CSL, FSL) signals causing the rising edge of P_CK to fall within the coarse delay window T_{cd} and fine delay window T_{fd} in time interval S3.

Alternatively, the above problem may cause the edge of signal P_CK to fall within time interval S2. In this situation, the coarse phase detector 40 will not generate any right shift CSR or left shift signals CSL.

In both of the conditions described above, the delay time T_{d} of variable delay circuit 20 will not be correctly set. Therefore, it would be advantageous to determine variations in PVT conditions, so that the series number of the shift register array can be correctly preset and the delay time of a variable delay circuit will meet the delay requirements (e.g., setup time and hold time of a synchronous logic unit).

Further, it would generally be advantageous in the related art to determine the effects of various PVT conditions on a chip for the purposes of programming the delay components of the chip or for designing circuits to compensate for the PVT conditions.

### SUMMARY OF THE INVENTION

The present invention provides a delay compensation circuit, which measures the effects of PVT variations and digitizes the results of such measurements. The delay compensation circuit therefore provides information relating to the PVT conditions of a chip, which can be used to control variable delay elements in the chip or to design circuits that compensate for PVT conditions.

In one exemplary embodiment of the present invention, the delay compensation circuit amplifies the maximum delay time of a variable delay element, which includes a plurality of delay components connected in series. The amplified delay time falls within one of several predefined time intervals. The delay compensation determines which time interval the amplified delay time falls within and accordingly generates signals, which provide information regarding the PVT conditions.

In another exemplary embodiment, the delay compensation circuit includes a loop and two digital counters. The variable delay element is included in the loop. A single pulse signal is repeatedly transmitted through the loop a specific number of times. Every time the single pulse is transmitted through the variable delay element, the first digital counter is incremented by one. The second digital counter counts the number of cycles of an input clock signal that elapses while the single pulse travels through the loop for the specific number of times. Therefore, according to the second counted signal, the delay compensation circuit determines the predefined time interval in which the total delay time of the variable delay element falls.

Another exemplary embodiment of the present invention provides an improved variable delay control circuit that includes a delay compensation circuit, which ensures that the delay time of a variable delay element meets the setup and hold time requirements of a synchronous logic element despite variations in PVT conditions.

In another exemplary embodiment, each of the delay components of the variable delay element is a tapped delay circuit. The delay compensation circuit correctly presets the series number in a shift register array immediately after the variable delay control circuit is powered on. After the delay compensation circuit determines the time interval in which the amplified delay time falls, a specific series number associated with the determined time interval is loaded into the shift register array in order to preset the series number for the coarse delay multiplexor of each tapped delay circuit. After the preset series number is loaded, the variable delay control circuit adjusts this series number, and well as the parallel number for the fine delay elements, until the delay of the variable delay element meets the necessary requirements.

In another exemplary embodiment, the variable delay control circuit of the present invention can be used with a plurality of digital chips having setup and hold time requirements. Such chips may include input and output buffers, field programmable gate arrays (FPGAs), delay-locked loops (DLLs), digital phase-locked loops (PLLs), D flip-flops, and other types of synchronous logic elements. In addition, the PVT information provided by the delay compensation device of the present invention can be used to design such chips for use in timing critical applications.

Advantages of the present invention will become more apparent from the detailed description given hereafter. However, it should be understood that the detailed description and specific examples, while indicating preferred embodiments of the invention, are given by way of illustration only, since various changes and modification within the spirit and scope of the invention will become apparent to those skilled in the art from this detailed description.

### BRIEF DESCRIPTION OF THE DRAWINGS

The present invention will become more fully understood from the detailed description given below and the accompanying drawings, which are given for purposes of illustration only, and thus do not limit the present invention.

FIG. 1A illustrates the operation of a D flip-flop in which the data signal is also used as the clock signal.

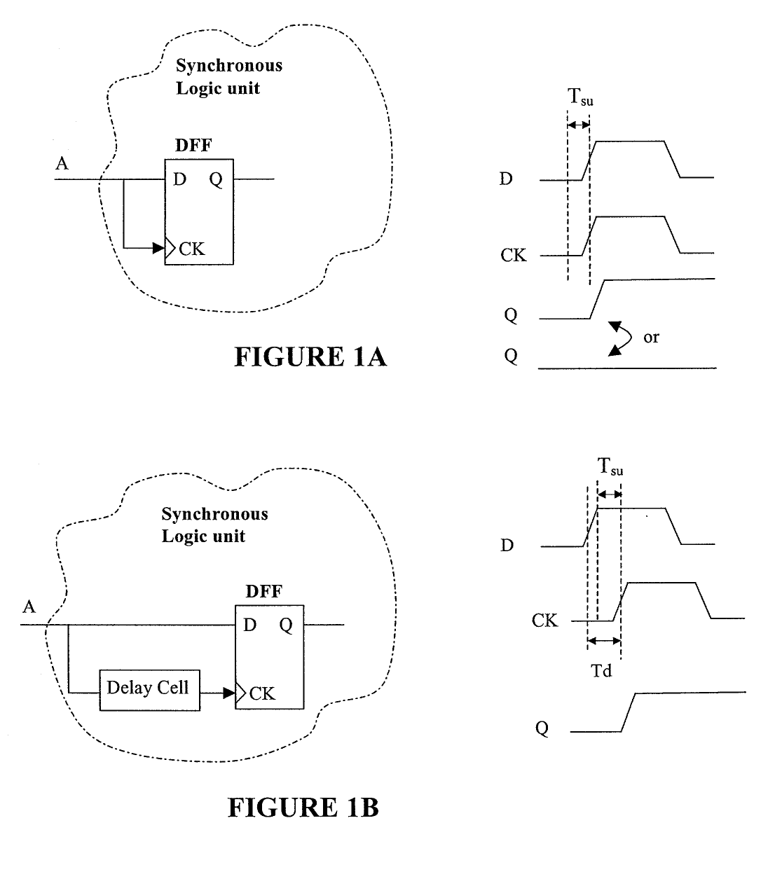

FIG. 1B illustrates the operation of a D flip-flop in which a delay element is inserted in the clock path.

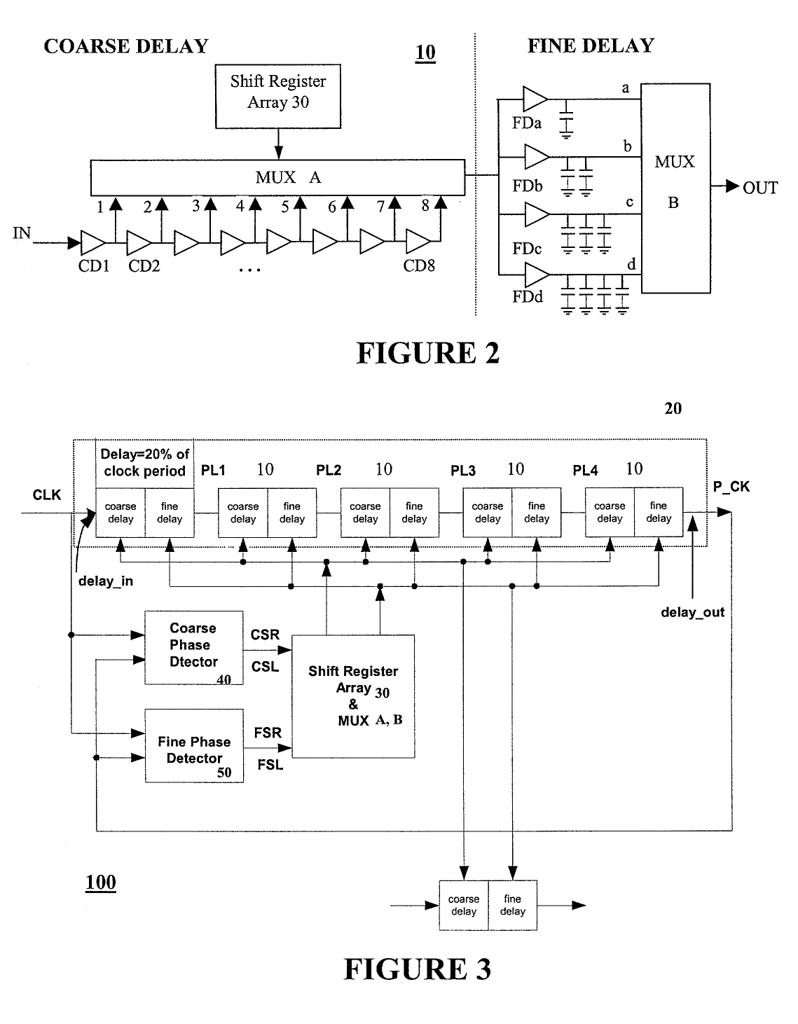

FIG. 2 illustrates a tapped delay circuit in the related art, which includes a coarse delay component and a fine delay component.

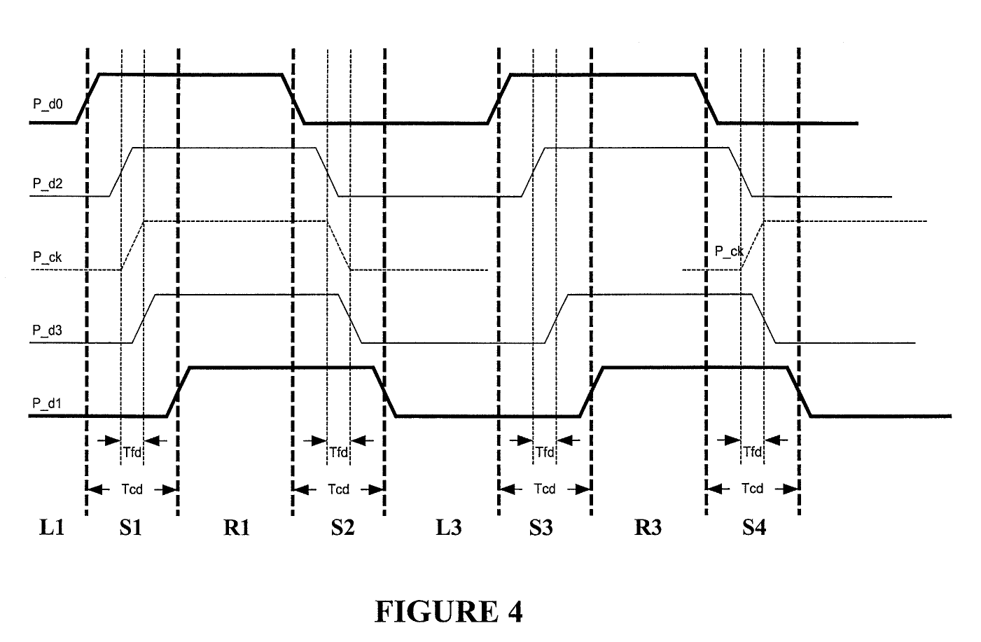

FIG. 3 illustrates a variable delay control circuit in the related art.

FIG. 4 illustrates a timing diagram including the internal signals of a coarse phase detector and fine phase detector used in the variable delay control circuit of the related art.

FIG. 5 illustrates a delay compensation circuit according to an exemplary embodiment of the present invention.

FIG. 6 illustrates a variable delay control circuit according to an exemplary embodiment of the present invention.

FIG. 7 illustrates a delay compensation circuit designed for use with the variable delay control circuit of FIG. 6.

FIGS. 8A-8F illustrate results of a circuit-level simulation of the operation of a variable control circuit according to the present invention, under worst case slow conditions.

FIG. 9A-C illustrate a circuit including an output buffer whose time critical design can be improved using the variable delay control circuit of the present invention.

### DETAILED DESCRIPTION OF EXEMPLARY EMBODIMENTS

As described above, the present invention is directed to a delay compensation device, which measures the effects of PVT variations on a chip by measuring variations in the delay time of a delay component in the chip. The delay compensation circuit of the present invention can be utilized to program the delay time of the delay component and for providing information to be used in chip design to compensate for PVT conditions. Many of the figures referred to in connection with this detailed description contain similar components. The same reference labels will be used throughout the figures to denote similar components.

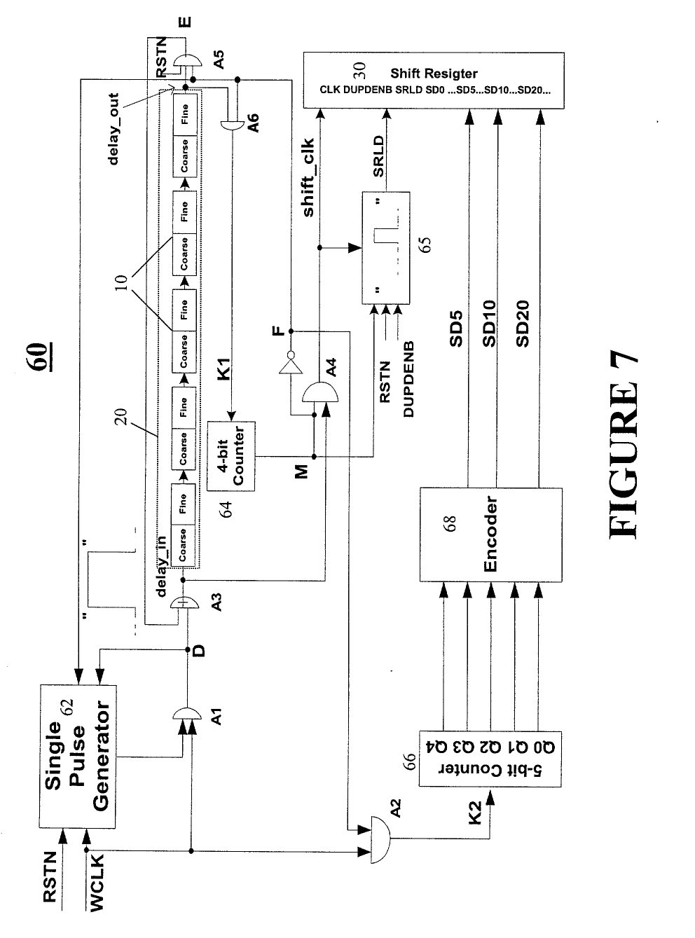

FIG. 5 illustrates a delay compensation circuit 60 according to an exemplary embodiment of the present invention. An input clock signal WCLK and reset signal RSTN are input to a single pulse generator 62. The input clock signal WCLK and the output of single pulse generator 62 are input to a two-input AND gate A1. The output signal D of AND gate A1 is fed to OR gate A3 and to single pulse generator 62. The output terminal of OR gate A3 is connected to variable delay element 20. The output of variable delay element 20 is connected to a three-input AND gate A5, as well as a two-input AND gate A6. The output of gate A5 is fed back to the second input of AND gate A3. The output K1 of AND gate A6 is connected to an m-bit digital counter 64, hereafter referred to as a pulse signal counter. The output of pulse signal counter 64 is sent to a two-input AND gate A4, which outputs the delayed clock signal WCLK′. The output of pulse signal counter 64 is also sent to an inverter. The output F of this inverter is connected to AND gates A5 and A6 and to signal pulse generator 62. The output F of the inverter is also connected to a two-input AND gate A2. This AND gate A2 also receives the input clock signal WCLK. The output of AND gate A2 is connected to an n-bit digital counter 66, hereafter referred to as an input signal counter. The outputs Q0, . . . , Qn of input signal counter 66 are connected to encoder 68, which outputs the encoded signal consisting of bits i₁, . . . iₙ.

The operation of the delay compensation circuit 60 will now be described. When the circuit is first powered on, signal RSTN resets the single pulse generator 62 and AND gate A5 to a logic value of zero. The rest of the nodes in circuit 60 are similarly reset as the circuit 60 is first powered on. When the input clock signal WCLK first goes to a high logic level after resetting, the single pulse generator generates a single pulse (high logic level) of a short period. The single pulse is transmitted through gate A1 to gate A3. In an exemplary embodiment, the single pulse generator 62 may comprise a pulse generator that generates pulses at a predefined interval. In such an embodiment, output D of gate A1 can be fed back to the single pulse generator 62, so that as signal D goes high after the first pulse, it prevents additional pulses from being generated by single pulse generator 62.

The single pulse travels from gate A3 to the “delay_in” input terminal of variable delay component 20 (whose delay time is set to maximum). Once the single pulse reaches the “delay_out” output of the variable delay component 20, it is transmitted via gate A6 to pulse signal counter 64. Pulse signal counter 64 is then incremented by one.

The pulse is looped back to the “delay_in” input of variable delay component 20, via gate A5, and propagates once again through the variable delay components. The single pulse repeatedly propagates this path until pulse signal counter 64 reaches a predetermined number K. While the single pulse is repeatedly propagating through the variable delay component 20, and before pulse signal counter reaches K, input signal counter 66 counts each rising edge of clock signal WCLK that occurs. Once pulse signal counter reaches K, it outputs a high level signal M that causes inverter output signal F to become low. Accordingly, the output K1 of AND gate A6 becomes low, thereby stopping the count of pulse signal counter 64. Similarly, the low signal F causes input signal counter 66 to stop counting, and further indicates to single pulse generator 62 that pulse signal counter 64 has completed its operation (i.e., counted up to K), allowing a new pulse to be generated.

At this point, the value W stored in input signal counter 66 represents the number of cycles of clock WCLK that occurs while a single pulse propagates K times through the variable delay component 20. If T_{d} represents the maximum delay time of the variable delay component 20, and T_{ck} represents the period of signal WCLK, then the following equation can be derived:

W*T_{ck}=K*T_{d} Eq. (1)

Therefore, the following relationship between T_{d} and W must be true:

T_{d}=(T_{ck}/K)*W Eq. (2)

Since the values T_{ck} and K are fixed, it is clear from equation (2) that the maximum delay time T_{d} of the variable delay component 20 is directly proportional to the value W. Therefore, the value W is directly related to the PVT conditions, that effects the delay time T_{d} of the variable delay component 20. Accordingly, the delay compensation circuit 60 can provide a measurement of PVT conditions by determining the count value W.

It should be noted that FIG. 5 illustrates an exemplary embodiment of the delay compensation circuit 60 of the present invention and should not be construed as limiting the present invention. Various modifications and changes may be made to this circuit 60 without departing from the spirit and scope of the invention. For example, instead of counting the number of rising edges, the input signal counter 66 may count the number of descending edges of clock signal WCLK. Further, the variable delay element 20 may comprise one unit whose delay time is varied according to control signals. In an alternative embodiment where the delay compensation circuit is used to measure PVT conditions without controlling delay time, the variable delay element 20 may be replaced with a delay component whose delay time is not controllable. Other such modifications that are covered by the present invention will be apparent to those of ordinary skill in the art.

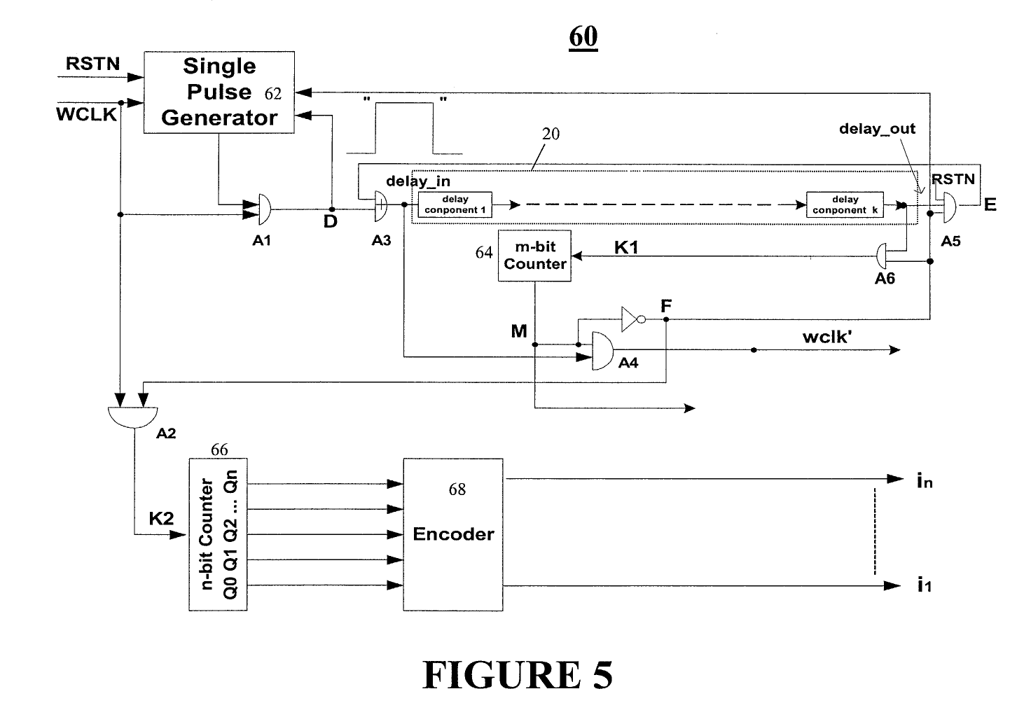

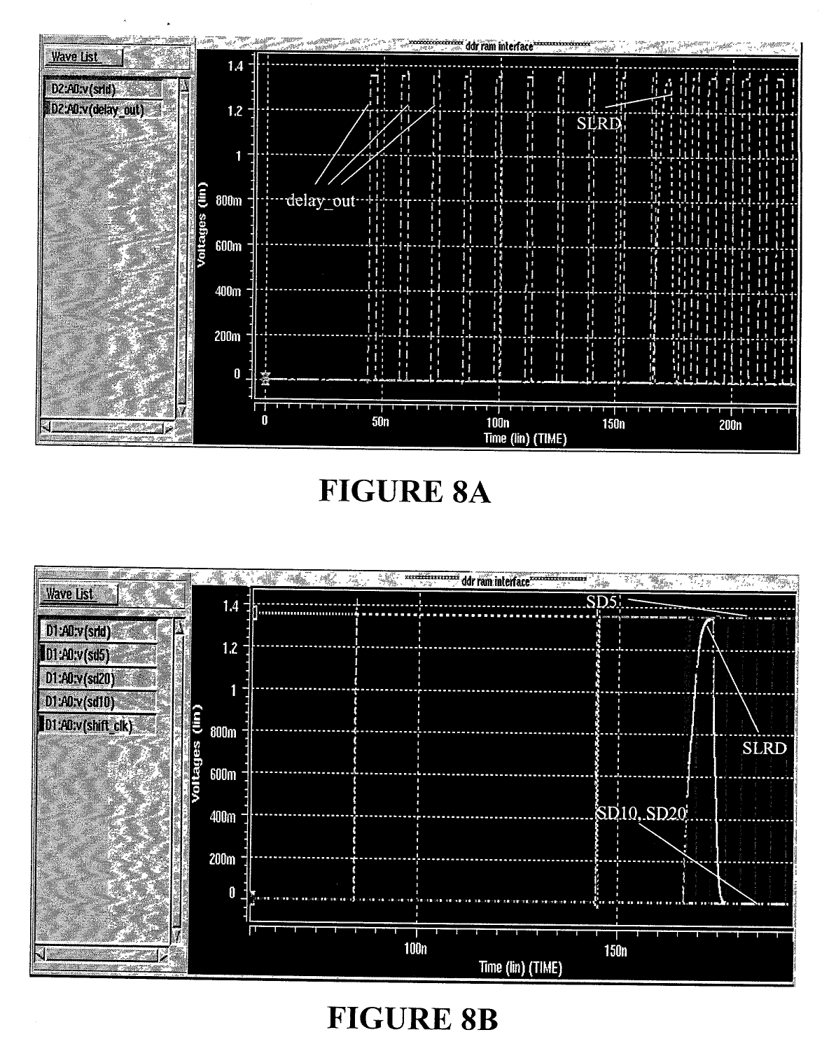

FIG. 6 illustrates a variable delay control circuit 200 according to an exemplary embodiment of the present invention. The circuits illustrated in FIG. 6 and in FIG. 3 are similar, the only difference being that the variable delay control circuit 200 of FIG. 6 contains delay compensation device 60 in circuit 200. The delay compensation device 60 is operable to preset the series number of the shift register array 30 after the variable delay control circuit 200 is first powered on.

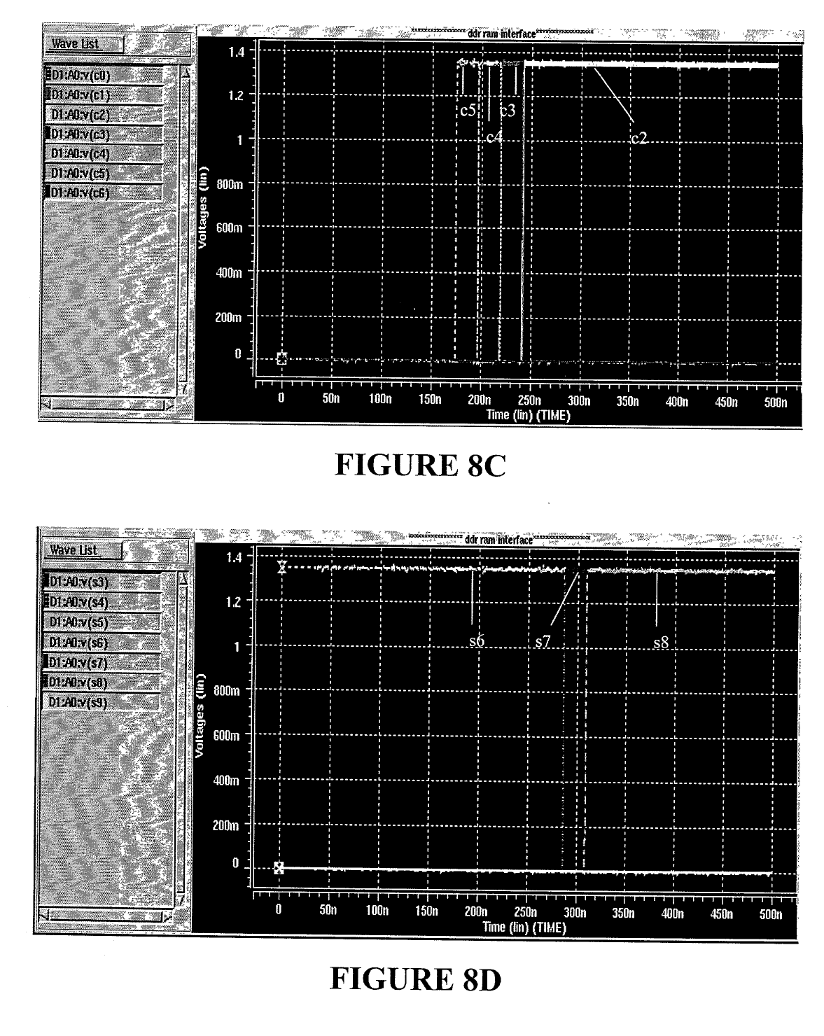

FIG. 7 illustrates a delay compensation circuit 60 specifically designed for use with the variable delay control circuit of FIG. 6. It should be noted that in one exemplary embodiment, the delay compensation circuit 60 may utilize the same variable delay component 20, which is found in variable delay control circuit 200 (i.e., the variable delay component 20 of FIG. 7 may be the same as the one in FIG. 6). In an alternative embodiment, the variable delay component 20 used by the circuit 60 of FIG. 7 may comprise identical components to the variable delay component 20 of FIG. 6.

In the delay compensation device 60 of FIG. 7, the outputs SD5, SD10, and SD20 of encoder 68 are connected to the shift register array 30 of the variable delay control circuit 200. Encoder 68 encodes the counted number W of input signal counter 66. After the single pulse has propagated through the delay component 20 a predetermined number of times, K, the signals SD5, SD10, and SD20 are output and used to control the delay time of the variable delay component 20.

Similar to the operation of circuit 60 in FIG. 5, when the count value of pulse signal counter 64 reaches the predetermined number K, signal M becomes high and signal F becomes low. The single pulse propagating through the variable delay component 20 is therefore diminished at AND gate A5. Further, signal F causes the single pulse generator to generate a constant high output signal. Therefore, the clock signal WCLK can pass through gates A3 and A4 to generate the “shift_clk” signal.

Signals M, “shift_clk,” and DUPDENB are input to the SRLD signal generator 65. DUPDENB is a “Delay Update Enable” control signal, which determines whether the delay compensation device 60 is operative to set a series number into the shift register array 30 by loading signals SD5, SD10, and SD20. For instance, should delay compensation device 60 be used only to preset the series number once, immediately after the variable delay control circuit 200 is powered on, then DUPDENB will have a high value only during the initial presetting. However, if DUPDENB is set high periodically, then the delay compensation circuit 60 can be used to periodically set the series number in the shift register array 30.

As a result of high M, DUPDENB, and “shift_clk” signals, SRLD signal generator 65 generates a high SRLD signal, which causes the encoder to load outputs SD5, SD10, and SD20.

As shown in FIG. 7, the variable delay component 20 comprises a plurality of tapped delay circuits 10 connected in series. FIG. 7 merely illustrates an exemplary embodiment. The variable delay component 20 can be any other delay component whose delay time can be adjusted by control signals.

In the exemplary embodiment of FIG. 7, the encoder 68 generates the serial number to be preset in the shift register array 30 based on the value of W, which is counted by input signal counter 66 (as described above with respect to FIG. 5). Should the value of W be very high, then the delay time of each tapped delay circuit 10 will also be very high according to equation (2). Therefore, a rather small series number should be preset in the shift register array 30.

For instance, if a tapped delay circuit 10 contains 25 coarse delay components, then encoder outputs SD5, SD10, and SD20 may correspond to series numbers 5, 10, and 20, respectively. As mentioned above, when input signal counter 66 counts a high value W, the series number will be preset to a low number. In response to a high value of W, the encoder 68 may generate a “1” bit at output SD5 and “0” bits at outputs SD10 and SD20 to preset the series number to a value of five.

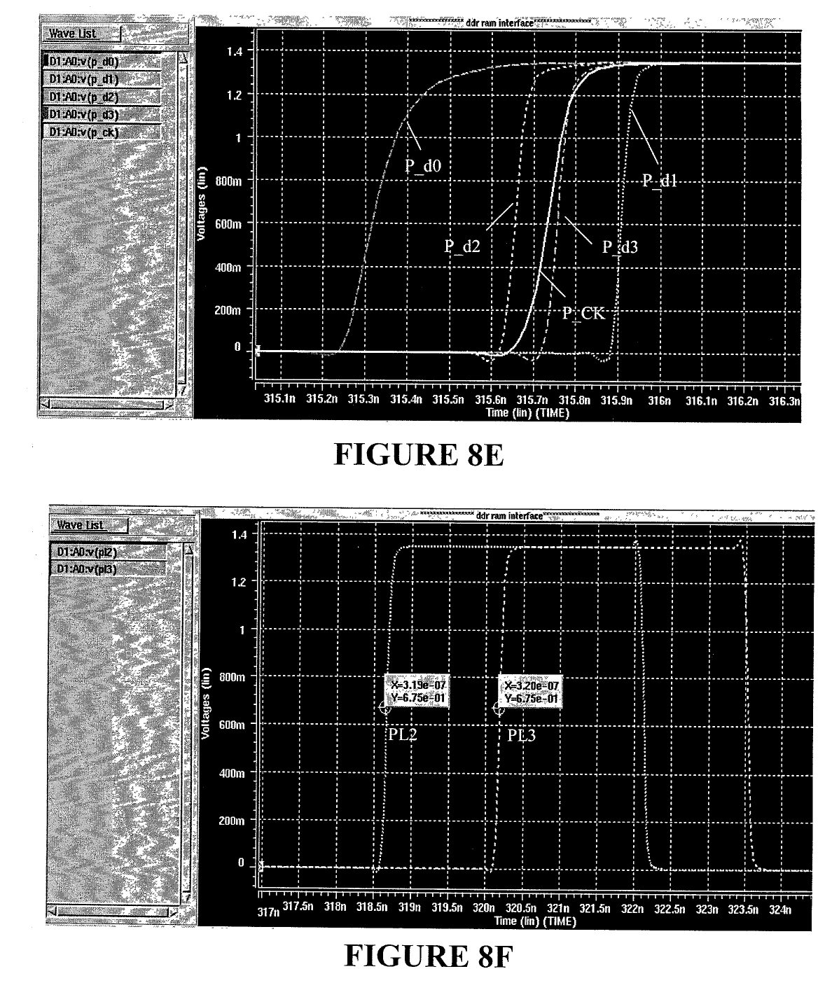

A circuit-level software simulation (using SPICE) of the variable delay control circuit 200 of FIG. 6 and the delay compensation device 60 of FIG. 7 will be described below with respect to FIGS. 8A-8F. According to this simulation, the variable delay control circuit 200 and the delay compensation device 60 are implemented in a DDR (double data rate) SDRAM controller for data read capture. The data clock is set at 133 megahertz (MHz). According to the chip design of the SDRAM controller, the optimal delay time of each tapped delay circuit 10 is 1.5 nanoseconds (ns). Since the data clock cycle is about 7.5 ns, the variable delay component 20 is designed to contain five tapped delay circuits.

It should be noted that one way to determine the number of coarse delay elements to be included in each tapped delay circuit 10 is to divide the optimal delay time of tapped delay circuit 10 by the minimum delay time T_{c} of one coarse delay element. For example, an optimal delay time of 1.5 ns and a minimum coarse delay element delay time T_{c} of 0.1 ns require at least fifteen coarse delay elements. Also, the number of fine delay elements can be determined by dividing the minimum delay time T_{c} of one of the coarse delay elements by the minimum delay time T_{f} of one fine delay element. For example, a minimum delay time T_{c} of 0.1 ns for each coarse delay element and a minimum delay time T_{f} of 0.01 ns for each fine delay element require ten fine delay elements.

In the simulation presently described with respect to FIGS. 8A-8F, the variable delay control circuit 200 is configured such that each tapped delay circuit 10 contains forty coarse delay elements and ten fine delay elements.

The delay compensation device 60 will amplify the maximum delay time T_{d} of the variable delay component 20, and determine one of three predefined time intervals in which T_{d} falls by determining the value of W after the single pulse has propagated K times through the delay component 20. The parameter K has been set at ten for the simulated delay compensation device 60.

The predefined time intervals of the maximum delay time T_{d} for this simulation are 0-4.25 ns, 4.25-11 ns, and 11 ns and above, correspond to the actual maximum delay time of each tapped delay circuit 10. Accordingly, if W is determined to be low, i.e., if the maximum delay time T_{d} of variable delay component 20 is determined to fall between 0 and 4.25 ns, then the encoder 68 will preset the series number to a high number by transmitting a “1” bit in SD20. Conversely, if W is determined to be high, i.e., the maximum delay time T_{d} is above 11 ns, then the encoder 68 will preset a low series number by transmitting a “1” bit in SD5.

In this particular simulation, the PVT parameters have been set according to the worst case slow conditions. FIGS. 8A-8F show signal waveforms at particular nodes of the simulated variable delay control circuit 200 and the delay compensation circuit 60.

FIG. 8A shows the simulated waveforms of the SRLD signal and the “delay_out” signal of delay compensation circuit 60. The tenth “delay_out” pulse occurs at 165 ns, indicating that the single pulse has propagated ten times through the variable delay component 20. In response, SRLD signal becomes high (at 166 ns), and encoder 68 loads the preset series number into the shift register array 30. FIG. 8B shows that for the worst case slow conditions, the SD5 signal (series number=5) becomes high (“1” bit), while the SD10 and SD20 signals become low (“0” bits), at 145 ns. Therefore, the outputs SD5=1, SD10=0, and SD20=0 are loaded into the shift register array at 166 ns.

FIG. 8C illustrates the control signals transmitted from the shift register array 30 to the coarse delay multiplexors MUXA in variable delay control circuit 200. In particular, FIG. 8C shows the shifting of the series number from its preset value to its final value. At about 175 ns, the series number is preset at five. This is indicated by signal c5 becoming high, where c5 is the control signal that communicates to the coarse delay multiplexors MUX A that the series number is five. After three shifts of the series number, in response to CSL signals generated by coarse phase detector 40, the series number is set to its final value of two, at about 240 ns. At this point, signal c2 becomes high. The control signal C2 communicates to the coarse delay multiplexors MUX A that the series number is two.

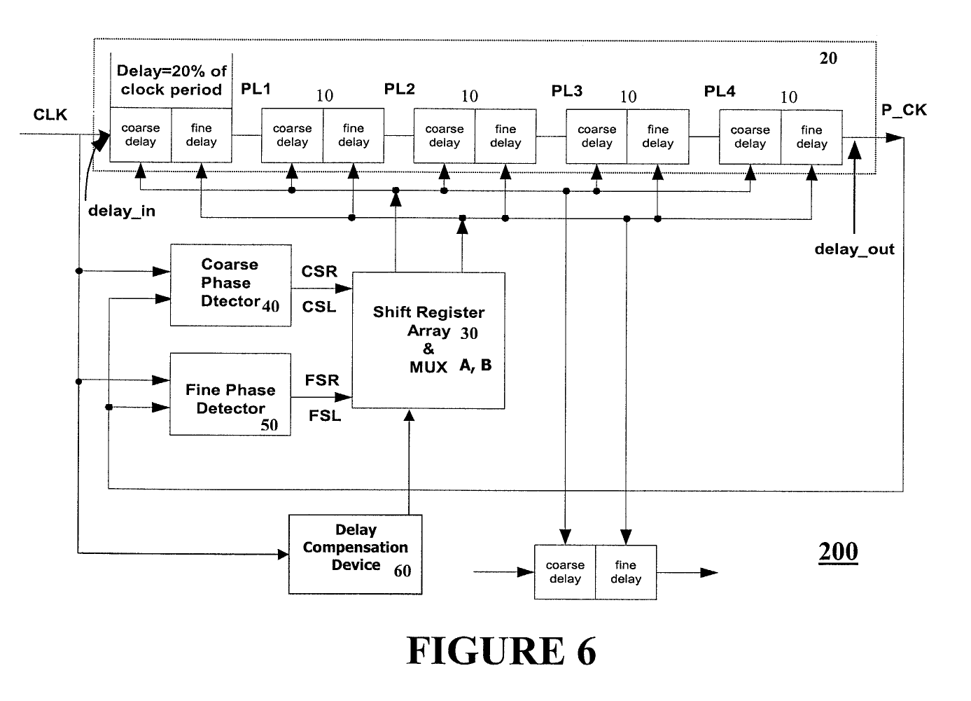

FIG. 8D illustrates the shifting of the parallel number according to signals generated by the fine phase detector 50 of variable delay control circuit 200. The parallel number is preset to S6 in the simulated circuit. Since the delay time of the fine delay component of each tapped delay circuit 10 is so small (about 1/100 of the delay time of the coarse delay component), the preset value of the parallel number will not affect the region where the delayed clock signal P_CK of variable delay control circuit 200 falls. Therefore the preset value of the parallel number will not cause any problems as described above with respect to FIG. 4.

FIG. 8D illustrates that the parallel number is shifted twice, from the preset value of six (where control signal s6 is high) to the final value of eight (where control signal s8 is high). The final setting of the parallel number to eight occurs at about 308 ns.

FIG. 8E illustrates that after the final setting of the parallel number, the signal P_CK becomes stable. This occurs at about 315.5 ns, at which point P_CK signal falls within time windows T_{cd} (between signals P_d0 and P_dl of FIG. 4) and T_{fd} (between signals P_d2 and P_d3 of FIG. 4).

FIG. 8F shows the signal waveforms at nodes PL2 and PL3 of the variable delay control circuit 200 in FIG. 6. The time difference between the signals PL2 and PL3 represents the delay time of one tapped delay circuit 10, whose series and parallel numbers are finally set. As shown in FIG. 8F, the rising edge of PL2 occurs at 318.6709 ns, while the rising edge of PL3 occurs at 320.1887 ns. Therefore, the delay time of the tapped delay element is 1.5178 ns (320.1887−318.6709=1.5178). This results in a 0.0178 ns error with respect to the designed delay time of 1.5 ns for each tapped delay element. Therefore variable delay control circuit 200 of the present invention meets the design requirement.

Similar simulations have been performed for the variable delay control circuit 100 of the related art. In the simulation, the variable delay control circuit 100 is automatically preset to 13 (i.e., about half of the maximum series number of 25). After the series number and parallel numbers are shifted to their final values, the delay time of each tapped delay circuit is determined to be 3.450 ns. This corresponds to an error of 1.950 with respect to the optimal delay time of 1.5 ns. Therefore, under worst case slow conditions, the variable delay control circuit 100 does not meet the design requirements of the SDRAM controller. Accordingly, the simulations show that the delay compensation device 60 provides the variable delay control circuit 200 of the present invention a marked improvement over the variable delay control circuit 100 of the related art.

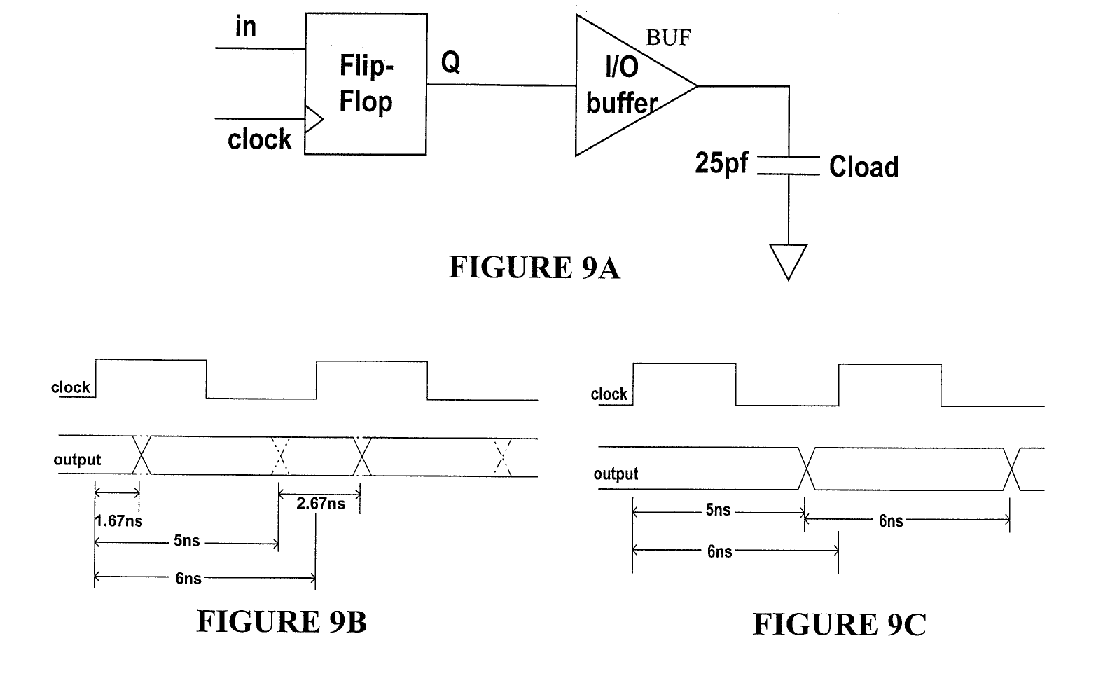

According to another exemplary embodiment of the invention, the variable delay control circuit 200 can be used with timing critical applications, in which circuits are designed to operate the same way regardless of the PVT conditions. FIG. 9A illustrates a particular timing critical application, in which the circuit includes an output buffer BUF. In particular, buffer BUF must have an operating time window that will perform the required data operations, regardless of whether the circuit is operating according to worst case slow conditions or worst case fast conditions (i.e., regardless of PVT conditions).

In circuits such as the one shown in FIG. 9A, the worst case slow conditions can have a derating factor between 2.0 and 4.0 with respect to the worst case fast conditions. For the circuit in FIG. 9A, a derating factor of 3 will be assumed. Accordingly, if the clock signal has a 5 ns delay from the clock input to the buffer BUF output under worst slow conditions, then the delay under worst fast conditions will be about 1.67 ns (5/3=1.67). Therefore, the clock delay window is 5−1.67 =3.33 ns (as shown in the timing diagram of FIG. 9B).

If the device connected to the output of buffer BUF has a setup requirement of 1.0 ns and a hold requirement of 0.5 ns, then the data valid window must be at least 1.5 ns. However, another 0.5 to 1.0 ns should be included in the data valid window to account for circuit board effects. Therefore, a data valid window can be as high as 2.5 ns, as shown in FIG. 9B. The operating window of buffer BUF, which is defined by the clock delay and the data valid portions, is about 6 ns (3.33+2.5=5.83 ns). Therefore, a data clock having a period of about 6 ns is required for the circuit of FIG. 9A.

However, the variable delay control circuit 200 of the present invention can be inserted in the clock path before buffer BUF to delay the clock signal. The variable delay control circuit 200 will control the delay to be nearly 0 ns for worst case slow conditions and 3.33 ns for worst case fast conditions. Therefore, the clock signal will be delayed for 5 ns by the variable delay control circuit 200 under all operating conditions, as shown in the timing diagram of FIG. 9C. Therefore, the 3.33 ns clock delay window caused by PVT variations can be eliminated from the operating window of buffer BUF, and the period of the clock signal can be reduced to about 3 ns. Accordingly, the variable delay control circuit 200 allows the clock signal frequency to be doubled.

Further, if a variable delay control circuit 200 and input buffer are used in conjunction with the device that receives the output of buffer BUF, the setup and hold times of this device can be significantly reduced (even reduced to nearly zero). Accordingly, the operating window of the circuit could be reduced to 1.5 ns, resulting in another doubling of the clock frequency.

The improvement of clock rate is one of the most important and challenging fields in chip design. The present invention can be used to improve the clock rates of chips used in many different applications. These applications may include input/output buffers, memories, FPGAs, digital PLLs, DLLs, synchronous logic elements, etc.

Another advantage of the present invention is that it consumes very little hardware because of the delay feedback loop structure of the delay compensation circuit 60. Therefore, the low number of gates needed for the delay compensation circuit allows for chip area and power consumption to be conserved.

The delay compensation circuit 60 of the present invention may be used in order to control the delay time of different types of variable delay elements used in a circuit. Further, the delay compensation circuit 60 may be used to measure the effects of PVT conditions and provide such information to circuit designers. Such measurements can be used to design chips that compensate for varying PVT conditions.

However, the present invention is not limited to compensating for PVT conditions. For example, clock skew may be caused by clock loading differences, lengths of interconnections, clock buffers, etc. in a chip. Therefore the variable delay control circuit 200 and the delay compensation device 60 may be used to compensate for, or to improve the design of, these elements within the chip.

The invention being thus described, it will be obvious that the same may be varied in many ways. Such variations are not to be regarded as a departure from the spirit and scope of the invention, and all such modifications as would be obvious to one skilled in the art are intended to be included with the scope of the following claims.

What is claimed is:

1. An apparatus comprising:
an input for inputting a signal;
a variable delay component through which a generated pulse signal is repeatedly propagated a number of times; and
an input signal counter for counting a number of cycles of said input signal that elapse during the propagation of said pulse signal for said number of times.

2. The apparatus of claim 1, wherein the delay time of said variable delay component is set according to the number of cycles counted by said input signal counter.

3. The apparatus of claim 1, further comprising a pulse signal counter for counting the number of times said pulse signal has propagated through said one or more delay components.

4. The apparatus of claim 3, wherein said input signal counter outputs a count after the count of said pulse signal counter reaches said number of times.

5. The apparatus of claim 1, wherein said variable delay component comprises one or more tapped delay circuit connected in series.

6. The apparatus of claim 5, wherein each of said one or more tapped delay circuits includes
a plurality of tapped coarse delay cells in series; and
a coarse delay multiplexor for outputting the signal from one of said plurality of tapped coarse delay cells according to a transmitted series number,
wherein the delay time of said variable delay component is set at least in part by said transmitted series number.

7. The apparatus of claim 6, wherein said each of said one or more tapped delay circuits further includes
a plurality of fine tapped delay cells connected in parallel, each of said plurality of fine tapped delay cells receiving the signal output from said coarse delay multiplexor; and
a fine delay multiplexor for outputting the signal of one of said plurality of fine tapped delay cells according to a transmitted parallel number,
wherein the delay time of said variable delay component is set based on said transmitted series number and said transmitted parallel number.

8. The apparatus of claim 1, further comprising an output for outputting a signal representative of PVT information of a microchip, said output signal being generated based on the count of said input signal counter.

9. A variable delay circuit comprising:
a variable delay component for delaying an input signal, said variable delay component including one or more tapped delay circuits connected in series, each of said one or more tapped delay circuits including
a plurality of tapped coarse delay cells connected in series, and
a coarse delay multiplexor for outputting the signal from one of said plurality of tapped coarse delay cells based on a determined series number;
a coarse phase detector for comparing the phase of said input signal and the delayed signal output by said delay component, said series number being increased or decreased based the comparison of said coarse phase detector; and
a setting device for setting said series number according to a variation in the delay component based on PVT.

10. The variable delay circuit of claim 9, wherein each of said one or more tapped delay circuits further including
a plurality of fine delay cells in parallel for receiving the selected signal from said coarse delay multiplexor, each fine delay component having a different associated delay time, and
a fine delay multiplexor for selecting a signal from said plurality of fine delay cells based on a determined parallel number.

11. The variable delay circuit of claim 10, further comprising:
a fine phase detector for comparing the phase of said input signal and the delayed signal output by said delay component, said parallel number being increased or decreased based on the comparison of said fine phase detector.

12. The variable delay circuit of claim 9, wherein said setting device sets said series number based on a counted number of cycles of said input signal that elapse during an amplified delay time of said variable delay component.

13. The variable delay circuit of claim 12, wherein said amplified delay time includes the time in which a single pulse signal repeatedly propagates a number of times through said one or more tapped delay circuits.
